(19) United States
(12) Patent Application Publication
(10) Pub. No.: US 2010/0020776 A1
(43) Pub. Date: Jan. 28, 2010

(54) Wireless network-based location approximation

(75) Inventors: Adel Amin Youssef, Milpitas, CA (US); Arunesh Mishra, Mountain View, CA (US); Sam Liang, Palo Alto, CA (US); Michael Chu, Los Altos, CA (US); Ravi Jain, Palo Alto, CA (US)

Correspondence Address: GOOGLE;Lerner, David, Littenberg, Krumholz & Mentlik, LLP, 600 South Avenue West, Westfield, NJ, 07090, US

(73) Assignee: Google Inc., Mountain View, CA (US)

(21) Appl. No.: 12/315,079

(22) Filed: Nov. 26, 2008

Related U.S. Application Data
(60) Provisional application No. 60/990,488, filed on Nov. 27, 2007.
(60) Provisional application No. 61/196,167, filed on Oct. 15, 2008.

(51) Int. Cl. H04W 8/02; H04W 24/00; H04W 4/02

(52) U.S. Cl. 370/338; 455/456.3

(57) ABSTRACT

The invention pertains to location approximation of devices, e.g., wireless access points and client devices in a wireless network. Location estimates may be obtained by observation/analysis of packets transmitted or received by the access point. For instance, data rate information associated with a packet is used to approximate the distance between a client device and the access point. This may be coupled with known positioning information to arrive at an approximate location for the access point. Confidence information and metrics about whether a device is an access point and the location of that device may also be determined. Accuracy of the location determination may be affected by factors including propagation and environmental factors, transmit power, antenna gain and diversity, etc. A location information database of access points may employ measurements from various devices over time. Such information may identify the location of client devices and provide location-based services to them.

### CROSS-REFERENCE TO RELATED APPLICATIONS

This application claims the benefit of the filing date of United States Provisional Patent Application No. 61/196,167, entitled “Wireless Network-Based Location Approximation,” attorney docket GOOGLE 3.8-020, filed Oct. 15, 2008, and of United States Provisional Patent Application No. 60/990,488, entitled “Accuracy Analysis of Wireless Base Station Location,” attorney docket number 2525.1180000, filed Nov. 27, 2007, the entire disclosures of which are hereby incorporated herein by reference.

### BACKGROUND OF THE INVENTION

1. Field of the Invention

The present invention relates generally to approximating the location of electronic devices such as wireless access points (“APs”) and client devices.

2. Description of Related Art

Wireless networks offer a wide variety of services using a number of different architectures. Client devices such as mobile phones, laptops and PDAs may connect to APs via cellular/PCS networks as well as wireless local area networks (“WLANs”) such as IEEE 802.11, Bluetooth® or other Wi-Fi® networks.

Location-based services can leverage the physical location of a client device to provide an enhanced service or experience for a user. A location-based service may determine the location of the user by using one of several technologies for determining position, then use the location and possibly other information to provide personalized applications and services.

Conventional cellular/PCS networks may position their APs (e.g., base stations) in accordance with specific coverage criteria. The locations of these base stations may be placed at known locations. Client devices in such networks may include GPS-enabled handsets, which enable accurate determination of the location of the devices.

In contrast, WLANs networks may include APs which are relatively small or portable (e.g., mini base stations or wireless routers), and which may be placed at locations as needed. The exact locations of APs in this situation may not be known. For instance, a corporate wireless network may have a number of APs distributed across the corporate campus. So long as the APs provide adequate coverage, a general knowledge of their location such as which building they are in may suffice.

Another type of scenario where the specific location of the APs may not be known is in a building-wide (e.g., an airport terminal) or city-wide mesh or ad-hoc WiFi network. In such cases, users may access APs set up by one or more service providers.

In such cases, the APs and client devices themselves may not be GPS-enabled. Or the devices may be located indoors or in other environments where GPS does not operate. Thus, it may be difficult or impossible to offer location-based services without some way to determine the positions of the APs and/or the client devices.

### BRIEF SUMMARY OF THE INVENTION

The present invention provides systems and methods for estimating AP locations as well as estimating the confidence and accuracy for such locations. Using such information, the locations of client devices may also be determined, which in turn enables the use of location-based services.

In accordance with an embodiment of the present invention, a computer-implemented method of estimating the location of a wireless device is provided. The method comprises obtaining a packet of data transmitted from a first wireless device to a second wireless device; determining whether one of the first and second wireless devices is a wireless access point; determining the data rate of the transmitted data packet; if one of the first and second wireless devices is the wireless access point, then evaluating the determined data rate against a predetermined criterion; and assigning an estimated location to the wireless access point based upon the evaluation.

In one alternative, the predetermined criterion is stored in a database such as in a look-up table. Here, the evaluation includes identifying a distance in the look-up table associated with the determined data rate. In one example, the transmitted data packet is obtained by a client device and the method further includes identifying a distance associated with the data rate, wherein the distance is used as a separation between the first wireless device and the client device. Here, if the client device is at a known location, then the method may further comprise assigning a distance between the wireless access point and the client device to be the same as the distance between the first wireless device and the client device; and triangulating a position of the wireless access device using the known location of the client device, the distance between the first wireless device and the client device and the distance between the wireless access point and the client device to obtain the estimated location. In this example, the client device may use a GPS receiver to obtain the known location.

In another alternative, the predetermined criterion includes a worst-case distance estimate based upon at least one parameter. In an example, the at least one parameter includes one or more of a channel propagation characteristic, a transmitter characteristic and a receiver characteristic.

In yet another alternative, the method further comprises revising the estimated location of the wireless access point based upon multiple data packets sent or received by the wireless access point.

In another alternative, the method further comprises determining a position of the client device based upon the estimated location of the wireless access point and providing a location-based service to the client device based on the determined position.

In accordance with another embodiment of the present invention, a computer-implemented method of estimating confidence in a status of a wireless device is provided. The method comprises obtaining one or more packets of data transmitted from a first wireless device to a second wireless device; evaluating the one or more transmitted data packets to identify a frame type for each respective data packet; identifying the first wireless device or the second wireless device as a wireless access point based upon the identified frame type for at least one of the data packets; and assigning a confidence value to the identification of the wireless access point.

In one alternative, if the frame type of at least one of the respective data packets is a management frame, then identifying the first wireless device as a wireless access point. In this case the method sets the confidence value for the identification of the wireless access point to a maximum confidence value. Optionally, if the frame type of at least one of the respective data packets is not the management frame, then the method evaluates whether the frame type of any of the respective data packets is a control frame. Here, if the frame type of at least one of the respective data packets is the control frame, then the method identifies the first wireless device as the wireless access point and sets the confidence value for the identification of the wireless access point to a value between the maximum confidence value and a minimum confidence value.

In another alternative, identifying the first wireless device or the second wireless device as the wireless access point further includes analyzing a number of frames transmitted or received by each device

In accordance with another embodiment of the present invention, a computer-implemented method of estimating confidence in a location of a wireless device is provided. Here, the method comprises obtaining one or more packets of data transmitted from a first wireless device to a second wireless device; determining that the first or second wireless device is a wireless access point based upon the transmitted packets; determining an estimated location of the wireless access point; and assigning a confidence value to the estimated location.

In one alternative, the confidence value represents a percentage likelihood that the wireless access point is contained within a specified area of interest. In another alternative, the estimated location is based on multiple data points. In this case, a confidence code may be applied to each data point. In one example, the confidence code for each data point is calculated using a weighted function. In another example, the confidence code for each data point represents a likelihood that that data point is valid or an outlier.

In yet another embodiment of the present invention, an apparatus for use in a wireless network comprises memory for storing information associated with a plurality of devices in the wireless network, means for communicating with one or more of the plurality of devices in the wireless network and a processor. The processor is operable to estimate a location of an access point device in the wireless network based upon data packet information sent to or received from the access point device. The processor is adapted to provide location based service information to one or more client devices associated with the access point device upon estimation of the location.

In one alternative, the data packet information for a given data packet includes a data rate of the given data packet. Here, the information stored in the memory includes distance estimates associated with different data rates. The processor determines the location estimate of the access point device by comparing the data rate of the given data packet to the different data rates and distance estimates stored in the memory.

In another alternative, the processor is operable to estimate the location of the access point device using the data packet information for multiple data packets sent to or received from the access point device. The processor is further operable to rank the data packet information for each of the multiple data packets to obtain approximate distances based upon each such packet. In one example, the processor estimates the location using a centroid of the approximate distances. In another example, the processor is further operable to assign a confidence in the estimated location of the access point device. The confidence may represent a likelihood that the access point device is within a given area. Optionally, the confidence is based upon at least one of spatial diversity of selected devices associated with the access point device, receiver characteristics of the selected devices, transmitter characteristics of the selected devices, and freshness of information stored in memory or the data packet information sent to or received from the access point device.

In yet another alternative, the processor comprises a plurality of processing devices in a distributed architecture and the memory stores the information so that the information is accessible to one or more of the plurality of processing devices.

Each of the aforementioned methods and processes may be performed by a processor such as a CPU, microprocessor, ASIC or other computing device. Furthermore, such methods and processes may be stored on a computer-readable recording medium (e.g., CD-ROM, DVD, Blue Ray disc, flash memory or the like) for execution by a processor.

### BRIEF DESCRIPTION OF THE DRAWINGS

FIG. 1 illustrates an exemplary wireless network in accordance with aspects of the present invention.

FIG. 2 illustrates aspects of a wireless network in accordance with aspects of the present invention.

FIG. 3 illustrates an exemplary configuration for estimating device location in accordance with aspects of the present invention.

FIG. 4 illustrates an exemplary confidence and positioning diagram in accordance with aspects of the present invention.

FIG. 5 illustrates an exemplary dynamic scenario for location estimation.

FIGS. 6A-B illustrate exemplary wireless devices for use with aspects of the present invention.

### DETAILED DESCRIPTION

The instant application is related to United States Provisional Patent Application No. 60/990,569, entitled “Locating Electronic Devices Using Passive Radios,” attorney docket number 16113-0938P01, filed Nov. 27, 2007, United States Provisional Patent Application No. 60/990,259, entitled “Estimating Location Using Cell ID and Application Specific Data,” attorney docket number 2525.1140000, filed Nov. 26, 2007, United States Provisional Patent Application No. 60/990,238, entitled “Disambiguation of Wireless Data Clusters Using Preclassification,” attorney docket number 2525.116000, filed Nov. 26, 2007, United States Provisional Patent Application No. 60/990,247, entitled “Method and System for Cell-Id Remapping Detection and Adaptation,” attorney docket number 2525.1170000, filed Nov. 26, 2007, and United States Provisional Patent Application No. 60/990,597, entitled “Wireless Base Station Location Estimation,” attorney docket number 2525.1150000, filed Nov. 27, 2007, the entire disclosures of which are hereby incorporated by reference herein.

The instant application is also related to U.S. patent application Ser. No. ______, entitled “Determining Location Information Using Passive Radios,” attorney docket number 16113-0938001, filed concurrently herewith, U.S. patent application Ser. No. ______, entitled “Systems and Methods for Estimating Location Using Cell ID and Application Specific Data,” attorney docket number 2525.1140001, filed concurrently herewith, U.S. patent application Ser. No. ______, entitled “Disambiguation of Wireless Data Clusters Using Preclassification,” attorney docket number 2525.116001, filed concurrently herewith, U.S. patent application Ser. No. ______, entitled “Method and System for Cell-Id Change Detection and Updating,” attorney docket number 2525.1170001, filed concurrently herewith, U.S. patent application Ser. No. ______, entitled “Wireless Base Station Location Estimation,” attorney docket number 2525.1150001, filed concurrently herewith, and U.S. patent application Ser. No. ______, entitled “Accuracy Analysis of Wireless Base Station Location,” attorney docket number 2525.1180001, filed concurrently herewith, the entire disclosures of which are hereby incorporated by reference herein.

The aspects, features and advantages of the present invention will be appreciated when considered with reference to the following description of preferred embodiments and accompanying figures. The same reference numbers in different drawings may identify the same or similar elements. Furthermore, the following description does not limit the present invention; rather, the scope of the invention is defined by the appended claims and equivalents.

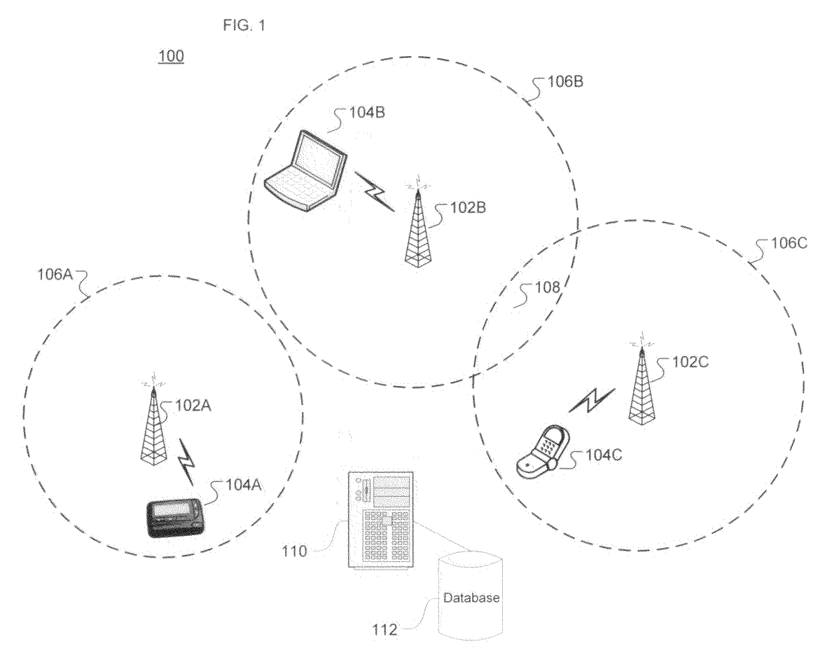

FIG. 1 provides an exemplary WLAN 100 which may have a number of APs 102 (e.g., 102A, 102B and 102C) as well as one or more client devices 104 (e.g., 104A, 104B and 104C) as shown. The APs 102 may include devices of different types from various manufacturers and may have different capabilities. Some APs 102 may be wireless routers that can support dozens of client devices or more, while some APs may act as signal repeaters. The client devices 104 may also be of different types and have different capabilities. For instance, as shown client device 104A may be a PDA, 104B may be a laptop/notebook computer, and 104C may be a mobile phone.

The WLAN 100 may also include a server 110 that is in wired or wireless communication with some or all of the APs 102. A database 112 may be associated with the server 110. The database 112 may be used to store data related to the APs 102 and/or the client devices 104. For instance, the database 112 may maintain location-related records for the APs 102.

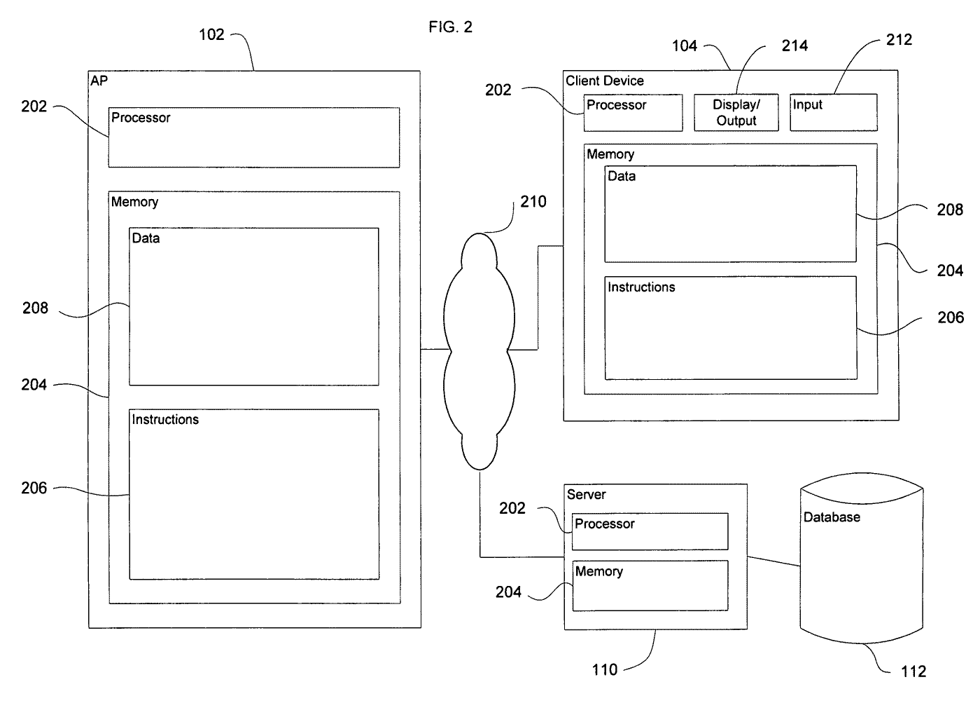

Each AP 102, each client device 104 and the server 110 may contain at least one processor, memory and other components typically present in a computer. FIG. 2 illustrates an alternative view 200 of a single AP 102, a single client device 104 and server 110 identifying such components. As shown, the AP 102 includes a processor 202 and memory 204. Components such as a transceiver, power supply and the like are not shown in any of the devices of FIG. 2.

Memory 204 stores information accessible by the processor 202, including instructions 206 that may be executed by the processor 202 and data 208 that may be retrieved, manipulated or stored by the processor. The memory may be of any type capable of storing information accessible by the processor, such as a hard-drive, ROM, RAM, CD-ROM, flash memories, write-capable or read-only memories. The processor 202 may comprise any number of well known processors, such as processors from Intel Corporation. Alternatively, the processor may be a dedicated controller for executing operations, such as an ASIC.

The instructions 206 may comprise any set of instructions to be executed directly (such as machine code) or indirectly (such as scripts) by the processor. In that regard, the terms “instructions,” “steps” and “programs” may be used interchangeably herein. The instructions may be stored in any computer language or format, such as in object code or modules of source code. The functions, methods and routines of instructions in accordance with the present invention are explained in more detail below.

Data 208 may be retrieved, stored or modified by processor 202 in accordance with the instructions 206. The data may be stored as a collection of data. For instance, although the invention is not limited by any particular data structure, the data may be stored in computer registers, in a relational database as a table having a plurality of different fields and records.

The data may also be formatted in any computer readable format such as, but not limited to, binary values, ASCII or EBCDIC (Extended Binary-Coded Decimal Interchange Code). Moreover, the data may include any information sufficient to identify the relevant information, such as descriptive text, proprietary codes, pointers, references to data stored in other memories (including other network locations) or information which is used by a function to calculate the relevant data.

Although the processor 202 and memory 204 are functionally illustrated in FIG. 2 as being within the same block, it will be understood that the processor and memory may actually comprise multiple processors and memories that may or may not be stored within the same physical housing or location. For example, some or all of the instructions and data may be stored on a removable CD-ROM and others within a read-only computer chip. Some or all of the instructions and data may be stored in a location physically remote from, yet still accessible by, the processor 202. Similarly, the processor 202 may actually comprise a collection of processors which may or may not operate in parallel. Data may be distributed and stored across multiple memories 204 such as hard drives or the like.

In one aspect, AP 102 communicates with one or more client devices 104 and the server 110 via wireless network 210 (e.g., a Wi-Fi®-type network such as an 802.11 g network or a Bluetooth®-type network). Each client device 104 and the server 110 may be configured similarly to the AP 102 with a processor 202, memory 204 and instructions 206, as well as one or more user input devices 212 and a user output device, such as display 214. Each client device 104 and the server 110 may be a general purpose computer, intended for use by a person, having all the components normally found in a personal computer such as a central processing unit (“CPU”), display, CD-ROM or DVD drive, hard-drive, mouse, keyboard, touch-sensitive screen, speakers, microphone, wireless modem and all of the components used for connecting these elements to one another.

Each device on the network 100 may transmit and receive data (packets) according to a known protocol in a segment (channel) of allotted portion the spectrum (frequency band). For instance, the IEEE 802.11 series of protocols specifies the format of various types of packets which may be transmitted in preset channels of the spectrum, such as the ISM band located in the 2.4 GHz frequency range or the public safety band located in the 4.9 GHz frequency range.

Depending upon their configuration, each AP may have a coverage area 106 such as coverage areas 106A, 106B and 106C as shown in FIG. 1. In many instances the coverage areas 106 of adjacent APs 102 may overlap, such as shown by overlap region 108. It should be understood that the coverage areas 106 in real-world implementations may be affected due to transmit power requirements, signal attenuation, multipath and other factors.

As discussed above, it is desirable to provide location-based services to client devices. While some client devices may include a GPS receiver or some other tool to determine and/or communicate the device's location, many client devices may not have such equipment or capabilities. Thus, in accordance with one aspect of the present invention, the location of a given client device may be determined based upon the location(s) of one or more APs, either alone or in conjunction with other network-related information.

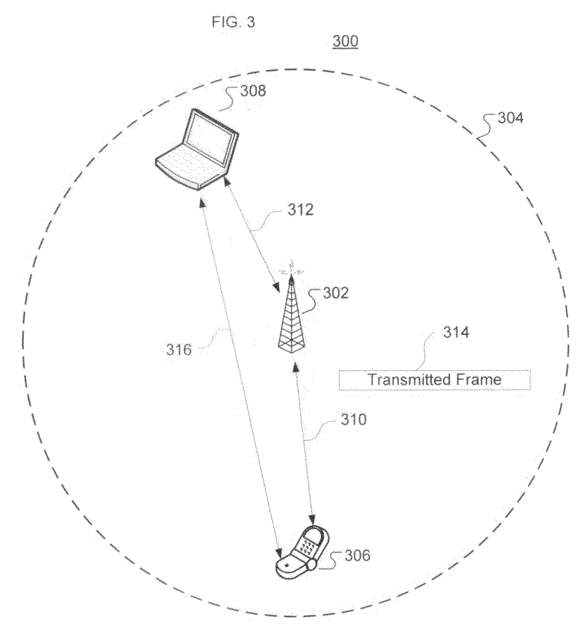

In such a scenario, one important issue is that in many instances the specific location of an AP 102 may not be known. Therefore, in accordance with another aspect of the present invention, systems and methods are provided to estimate an AP's location using data rate information between the AP and one or more client devices. FIG. 3 illustrates an exemplary configuration 300 with a single AP 302 having a coverage area 304. A first client device 306 and a second client device 308 are located within the coverage area 304.

In the present example, the client device 306 may be “associated” with the AP 302, transmitting packets to and receiving packets from the AP 302. Here, the client device 306 is not GPS enabled and is not otherwise configured to determine its location. In contrast, the client device 308 may include a GPS receiver or other means of performing geolocation.

In this example, the client device 306 is located a first distance 310 from the AP 302, while the client device 308 is located a second distance 312 from the AP. And the client device 306 is located a third distance 316 from the client device 308. The client device 308 performs geolocation using its GPS receiver or by other means to accurately determine its location.

Furthermore, the client device 308 may be configured to observe or capture data packets such as frame 314 transmitted to or from the AP 302. By way of example, the client device 308 may be a laptop having a wireless transceiver that can operate in a “sniffer” or “monitor” mode, thereby handling transmitted frames 314 without requiring the client device 308 to be associated with the AP 302.

In accordance with one embodiment, the client device 308 receives and captures the frame(s) 314. The client device 308 may analyze the frame 314, such as with an analyzer program executed by its processor. Alternatively, the server 110 may execute the analyzer program. The analyzer program may parse different portions of the frame 314 and perform error checking on the frame 314. As part of the analysis, it is determined which device (e.g., AP 302 or client device 306) transmitted the frame 314, as well as the data rate at which the transmitter sent the frame 314. The data rate may be identified by data in the frame 314 itself or may be otherwise identifiable. For example, the data rate is the rate of transmission from the AP 302 to the client device 306 or from the client device 306 to the AP 302. Alternatively, if the client device 308 is associated with the AP 302 and is communicating with the AP 302 (as opposed to merely sniffing packets), then the data rate may be the rate transmitted from the AP 302 to the client device 308 or from the client device 308 to the AP 302.

Using this information, the client device 308 or the server 110 may estimate the distance of the client device 308 relative to the AP 302 and/or the client device 306. For instance, the data rate may be used as an estimate of channel quality to indicate the physical separation between client device 308 and the AP 302 or between the client device 308 and the client device 306. In one example, a look-up table may be used to estimate the distance. An exemplary look-up table is provided below.

| Rate | Distance |
|---|---|
| 5 Mbps | 250 meters |
| 10 Mbps | 125 meters |
| 54 Mbps | 30 meters |

As shown in this example, the higher the data rate, the shorter the distance. However, the distance may be adjusted by various parameters as will be discussed below. The distances in the look-up table may be approximated using a worst-case estimate based on various channel parameters such as propagation characteristics, transmit power, antenna gain, receiver sensitivity and other radio characteristics for both the transmitter and receiver, as well as terrain type, etc.

In accordance with another aspect, so long as the client device 308 is able to capture and properly decode a packet containing a transmitted frame, then it is determined that the distance between the client device 308 and the transmitting entity (e.g., AP 302 or client device 306) must fall within the worst-case estimate. If the client device 308 is not associated with the AP 302, then some platforms may not provide or process certain frames. In the case where client device 308 is associated with the AP 302, then more information about the AP 302 may be available which can be used to improve the accuracy of the AP's location. For instance, in addition to the frames that client device 308 observes between the AP 302 and the client device 306, client device 308 also has frames transmitted to itself by the AP 302. These frames also have data rate information associated with them, so this is another opportunity to obtain an estimate of the distance between the AP 302 and the client device 308.

Thus, in one alternative the frame(s) observed between AP 302 and client device 306 provide a first estimate or multiple estimates which can be used to determine a first approximate distance 312, while the frame(s) received by the client device 308 from AP 302 provide a first estimate or multiple estimates which can be used to determine a second approximate distance 312. In this case, weights or rankings may be applied to the first and second approximate distances to arrive at a resultant distance 312. Of course, it should be understood that there may be other client devices within the area 304 in communication with the AP 302. In that situation, there may be even more approximate distances 312 calculated/weighted to arrive at an even more accurate resultant distance 312.

If the packet cannot be decoded or is decoded with uncorrectable errors, then the distance approximation may not be performed. Alternatively, if the packet cannot be decoded properly, it may be inferred that the distance 312 between AP 302 and client device 308 is greater than the distance 310 between the AP 302 and the client device 306.

The above look-up table may be supplemented or otherwise parameterized based upon additional factors besides distance. For instance, the table can be parameterized based upon the transmit power values of the transmitter. Or if the transmit power values are unknown, a certain distribution of common transmit power values can be used as an approximation. The table can also be parameterized based upon the environment where the packet/frame was captured. For example, in a dense urban environment, one may expect a high multipath coefficient. On the other hand, in a rural environment, one may expect the propagation pattern to be very symmetric, leading to larger distances for the same data rate. The table could also be parameterized based upon the receiver's radio characteristics, such as the sensitivity, antenna gain and any diversity metrics (e.g., multiple antennas) which may be applicable.

Calibration or otherwise updating of the look-up table may be done based on the power, radio sensitivity and/or vendor information of the various devices. For instance, different radios may have very different RF characteristics. Some APs are operable to transmit at higher power than others. Thus, at the same data rate, a higher power AP may be located farther away than a lower power AP.

Similarly, it may be beneficial to evaluate the sensitivity of the receiver of the client device 308. By way of example, a dedicated sniffer/scanner may have a much higher gain antenna/receive chain than the radio receiver on a laptop, which in turn may have a higher gain than the radio on a cellular phone.

Vendor and model information for a given device and its radio/receiver may be determined based upon the device's MAC address (e.g., using the object identifier (“OID”)) and frames transmitted by the device. This in turn may be used to evaluate the power and sensitivity of the radio/receiver.

Once the packet containing a frame is properly decoded, the frame may be examined to determine whether it was sent by the AP 302 or the client device 306 (or some other entity). This information may provide additional insight into the specifications of the particular AP 302 or client device 306. For instance, if the frame information identifies the AP 302 as being of a specific type, then that may indicate the power level(s) at which the AP 302 operates.

If the decoded frame was sent by the AP 302, then the distance determined using the look-up table gives an accurate upper bound on the separation between the client device 308 and the AP 302. This is coupled with the location of the client device 308 provided by its self-geolocation. Thus, starting with the client device 308 at a center point of a circle similar to the coverage area 304, the AP 302 can be determined to be within a radius of the circle, where the radius is the distance identified by the look-up table.

If the decoded frame was sent by the client device 306, then the distance determined using the look-up table identifies the maximum separation between the client device 306 and the client device 308. Similarly, the distance determined using the data rate (and possibly other information) in the look-up table also provides the maximum separation between the client device 306 and the AP 302. Using the geometrical principal known as the Triangle Inequality, the maximum separation between the AP 302 and the client device 308 is no more than twice the distance determined using the look-up table.

As discussed above, because the client device 308 has a GPS receiver or can otherwise determine its position using geolocation, the location of client device 308 is known. Thus, in accordance with another aspect of the invention, the location of the AP 302 is determined by triangulating using the distance between the client devices 306 and 308 and the distance between the AP 302 and the client device 308.

This process may be repeated by analyzing multiple packets sent between the AP 302 and the client device 306 (or other client devices falling within the coverage area 304. Multiple estimates of the location of the AP 302 may be made by the client device 308 and/or other client devices having geolocation capabilities.

Alternatively, an estimate of the location of the AP 302 may be performed using a centroid (mean location) of multiple points associated with the AP 302. These points may correspond to locations obtained by the same or different client devices 308 using the AP 302 at the same or different times. A coverage radius of the AP 302 may also be estimated so that most or all the points in a collection are covered.

Once a given packet/frame has been captured and decoded by the client device 308, then the location estimation process for the AP 302 may be done by the client device 308, the AP 302 or other entity such as server 110 of FIG. 1. By way of example only, the look-up table may be stored in database 112. This database may be accessible only to the server 110, to some or all of the APs 102, and/or to some or all of the client devices 104. Alternatively, the database 112 may be a distributed database spread among various nodes of the wireless network, including some of the APs 102 and/or the server 110.

Returning to FIG. 3, once the location of the AP 302 has been estimated, then that information may be used to provide location-based services to the client device 306. For instance, this may be done relying solely on the location of the AP 302, and that location estimate is used when offering location-enabled features to the user of the client device 306. Alternatively, the location of the client device 306 itself may be determined using the processes discussed above with regard to the AP 302. Here, for example, once the AP 302 location has been estimated, the Triangle Inequality or other geolocation technique (e.g., time difference of arrival (“TDOA”), angle of arrival (“AOA”), etc.) may be used to estimate the location of the client device 306. As above, repeated measurements may be used to determine the location before or during offering location-enabled services to the user of the client device 306.

In accordance with other aspects of the present invention, the confidence of the location of an AP may be estimated. The confidence determination may include an evaluation as to whether the transmitting entity is in fact an AP. And the confidence determination may evaluation the relative accuracy of the physical location for that transmitting entity.

In one evaluation, it is important to determine whether the device of interest is really an AP. This may be done by evaluating different types of frames sent to (or received from) the device of interest. Depending upon the protocol of the WLAN, there may be management frames, control frames, data frames, etc. which are sent and received by devices in the network. In the example of FIG. 3, if the client device 308 decodes a management frame such as a beacon frame, then it is determined that the transmitting entity is the AP 302. However, if the decoded frame is a control frame such as a “Request To Send” (“RTS”), “Clear to Send” (“CTS”), “Acknowledgement” (“ACK”), “Power Save-Poll” (“PS-POLL”), or “Contention Free-End” (“CF-END”), then the transmitter may or may not be the AP 302.

Another indicator of whether the device of interest is the AP 302 is the number of frames it transmits. For example, a high number of frames such as control frames sent over a short period of time (e.g., 100 control frames sent in 2 minutes) may suggest that the device is an AP. Similarly, a high number of frames received may also suggest that the device is an AP.

Data and metrics concerning the device of interest may be obtained by various client devices 308 at the same or different periods of time. Such information may be stored in a database such as database 112. These various indicators are analyzed to provide some value of confidence that the device is an AP. By way of example only, the confidence may be expressed as a percentage value (e.g., 90%) that the device of interest is an AP. An exemplary algorithm may rely on a number of factors to obtain confidence levels/values. For instance, spatial, temporal and/or platform diversity of GPS measurements would be relevant. Also, the types of frames that are used in the measurement, such as data frames, management frames and/or control frames may affect the confidence. And the source of the measurement may be a relevant factor, such as if it is a trusted party providing the readings versus uploading them through an Open API implementation.

In another evaluation, the confidence in the location of the AP 302 is determined. Here, the confidence may be expressed as a percentage, e.g., that it is 90% likely that the device of interest is within a certain radius/area). Factors affecting this analysis include spatial diversity of the different client devices which interact with the AP. In addition, whether the client devices are of different types may be relevant to the evaluation. For instance, the antenna gain and overall robustness of the receiver may impact the accuracy of the measurements taken. Here, the data taken by a high quality receiver with multiple spatially diverse antennas having high gain may be given a higher weight in the analysis than data taken from a receiver with a single, low gain antenna.

Furthermore, the accuracy of the GPS or other geolocation measurements may affect the accuracy calculation. Here, for instance, a differential GPS receiver may be determine the client device 308's position to within a meter or less, while a non-differential GPS receiver may determine the position to within 5-25 meters or more. In addition, while the accuracy of a GPS measurement outdoors with a clear view of the sky may be close to optimum, performance degradations may occur in urban canyon environments where fewer satellites are “visible” and especially when the GPS receiver is located indoors. In the latter case, the GPS receiver may be unable to fix a location at all. Also the “freshness” of the data collected may be relevant to the confidence determination. Here, more recent data may be given a higher weight in the analysis than older data. As above, an exemplary algorithm may rely on a number of additional factors to obtain accuracy. For instance, spatial, temporal and/or platform diversity of GPS measurements would be relevant. Also, the types of frames that are used in the measurement, such as data frames, management frames and/or control frames may affect the confidence. And the source of the measurement may be a relevant factor, such as if it is a trusted party providing the readings versus uploading them through an Open API implementation.

In accordance with another aspect of the present invention, processes to determine the accuracy of AP locations are provided. In one embodiment, the measurements taken by various client devices determine a confidence that a given AP is within a certain area. One or more data points represented the expected position of the given AP may be calculated based upon the various factors discussed herein. A “confidence code” may be applied to each data point.

The confidence code may be calculated using a weighted function. The weights used by the weighted function may be obtained based on information of the collected data such as size of the collection (e.g., the cardinality or number of points in the collection), platform information of the client devices, temporal and/or spatial diversity of the points corresponding to the client devices, etc. One or more estimates of the location of the AP may be adjusted based on the calculated confidence code. A Monte Carlo-type analysis may also be performed.

In order to provide more accurate estimation of AP locations and coverage regions, several factors can be taken into account to analyze the accuracy of such estimations. The factors may include the number of points, platform information of corresponding client devices, temporal diversity of the points, spatial diversity of the points, etc. For example, the estimated location for a given AP will be more accurate when using more points for the estimation.

More variety of platforms of client devices indicates more users for the AP, and may increase the accuracy of the estimation. With regard to temporal diversity, points spanning multiple distinct times may contribute to a more accurate estimation than points spanning fewer distinct times. Also, with regard to spatial diversity, more accurate estimation can be achieved by using points spread in a larger space than points clustered in a smaller area. A weight function can be used to calculate a confidence code based on the above information. Accordingly, the estimated location and coverage radius for the given AP can be adjusted based on the confidence code.

In one example, the confidence code represents the likelihood that a particular data point is valid or an outlier. For instance, this may be expressed as a percentage (e.g., 90% likely that the data point is valid), as a ranking (e.g., a 4 on a scale of 1-5, with 1 being the lowest confidence and 5 being the highest confidence), or some other relative indicator. The confidence code may then be used to discard outliers. Once this is done, the system may compute a “best circle” representing the likely position of the AP of interest.

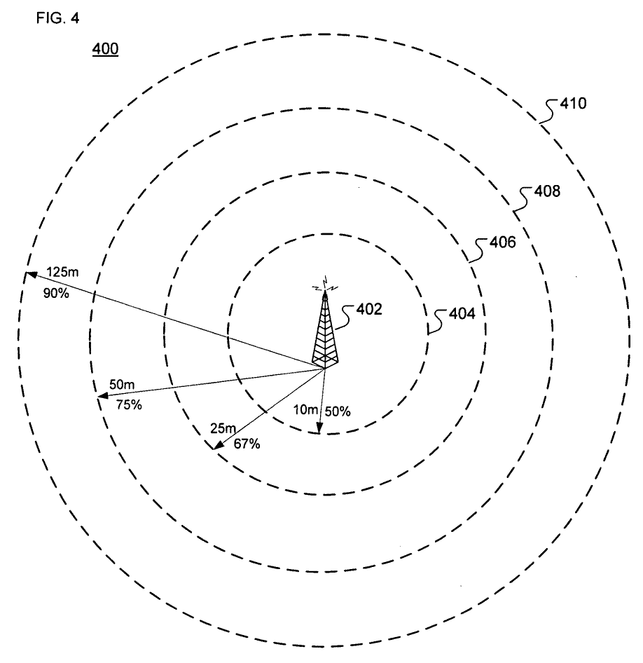

In an alternative, multiple circles may be provided as shown in the confidence and positioning diagram 400 of FIG. 4. In this example, AP 402 may be placed in the center of multiple concentric circles 404, 406, 408 and 410. Each circle may be associated with both an area and a confidence value. For instance, the innermost circle 404 may indicate that there is a 50% likelihood that the AP 402 is within 10 meters of the epicenter of that circle. The next smallest circle 406 may be used to indicate that there is a 67% likelihood of the AP 402 being within 25 meters of the epicenter of that circle. The next circle 408 may be used to indicate that there is a 75% likelihood of the AP 402 being within 50 meters of the epicenter of that circle. And the outermost circle 410 may be used to indicate that there is a 90% chance of the AP 402 being within 125 meters of the epicenter of that circle. In one example, an O(n²) algorithm may be used to detect outliers. This may be done as follows. First, the centroid of a given number of points may be computed. Then for each point, its distance to the centroid may be computed. If the distance for a given point exceeds a threshold, then the point may be marked or otherwise identified as an outlier. The process may be refined by removing some/all outliers and repeating the above. This may be repeated until there are no more outliers or the algorithm converges.

As discussed herein, the location of a given AP may be based on a number of measurements taken by one or more client devices. The raw data collected by a client device may be processed locally or sent to a central repository (e.g., server 110 of FIG. 1) for processing. Regardless of which device performs the calculations, each distance and/or each location estimate may be stored in a database, for instance as part of a location table. The location table may store, for one or more APs, a unique identifier for the AP (such as a MAC address, IP address or SSID), a location estimate (e.g., latitude and longitude coordinates and/or height), a time the location estimate was obtained/calculated, a coverage radius for the AP, a confidence for the location estimate (e.g., 90% likely to be within 50 meters of the specific position), equipment type (e.g., transceiver make/model) and/or RSSI information. If multiple location measurements are made, some or all of them may be stored in the location table. Calculated locations and associated estimates such as discussed above with regard to FIG. 4 may also be stored in the location table.

The server 110 may provide AP location information from the location table to users upon request. In addition, when a location is needed for a given client device, the server 110 may obtain relevant data for one or more APs from the location table and either provide them to the client device or perform location calculations for the client device's position.

By way of example, a client device without geolocation capabilities may perform a scanning or sniffing operation to obtain a list of all APs that can be observed by the client device. This list may then be evaluated against a database of APs such as the aforementioned location table to determine the specific or estimated locations of the observed APs. Given the (likely) AP locations, a location of the client device may be estimated as set forth above.

In accordance with other aspects of the present invention, the client devices may be stationary or may be moving. In either situation, the data rate between a given client device and a serving AP may change. This may be due to a number of factors such as multipath interference, error rates, etc. For example, a client device may use a maximum data rate (e.g., 54 Mbps) at first to communicate with an AP. If there is no ACK control frame received from the AP, then the client device may drop or back off its data rate to 24 Mpbs or less until it receives the ACK. Thus, in one example, changes in the data rate between a given client device and the AP may be used to refine the distance estimate. As different measurements may occur at different data rates, there may be multiple distance estimates and/or location estimates for a given AP. Statistical processing may be used to arrive at an average distance or most likely location estimate for a given confidence level. In the case where the client device includes a GPS receiver, if that device captures multiple frames relating to an AP, then it may also obtain multiple GPS measurements and use the data rate as a bounding factor. Such measurements of GPS signals and/or frames may be aggregated in a localization process to obtain a more accurate estimate for the AP's location.

It is also possible to use the frame size and checksum of the frame/packet to estimate distance and accuracy. For instance, the larger the frame size, the more likely it is that the frame may become corrupted during transmission. Thus, if the client device received/sniffs a large frame (e.g., 500 bytes) from an AP, then it is likely that the AP is closer than an average distance for the data rate that packet/frame is being transmitted at. Conversely, if the frame is very small (e.g., 10 bytes or less), then the distance may be farther than the average distance. The average distance may be computed or otherwise determined as part of the development of the look-up table. For instance, a mean value or median value calculation may be performed on multiple data points to arrive at the average distance. Furthermore, the look-up table may be constructed using an analytical model for bit error rate and use that information to determine how far away a device could be so that a packet could be received at a certain data rate. Or, in addition or alternatively, the look-up table could be constructed using experimental data.

In a further alternative, the WLAN of interest may permit multiple APs to share a single frequency channel, such as in a spread-spectrum based architecture. However, depending on the implementation, the various APs and/or client devices using a particular frequency channel may need to adjust their data rates and/or power levels in order to share the channel while maintaining an acceptable noise or error rate. In this scenario, if there are multiple APs using the same channel and the data rate is relatively low (e.g., at 1 Mbps instead of 54 Mbps), then the distance estimation for a given transmitter may be increased. The amount of increase may be related to the number of APs in the same channel. By way of example only, the distance estimation may be increased by a certain percentage such as on the order of 5-20%.

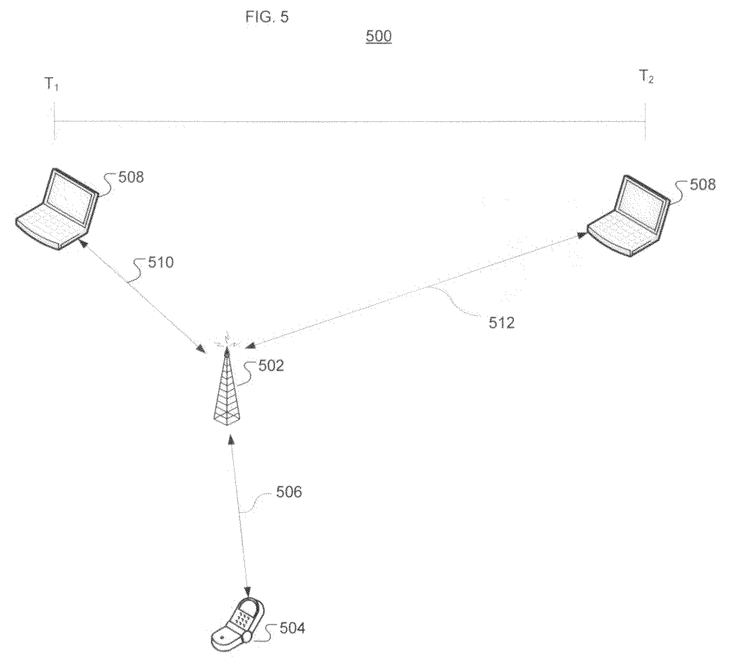

FIG. 5 illustrates an alternative scenario 500 wherein there is a single AP 502 and a first client device 504 associated with the AP 502 at a first distance 506 from the AP 502. The first client device 504 is stationary. In contrast, a second client device 508 moves from a first location at time T₁ to a second location at time T₂. At time T₁ the distance between the client device 508 and the AP 502 is shown by line 510, while at time T₂ the distance between the client device 508 and the AP 502 is shown by line 512.

In accordance with another aspect of the present invention, the system may compare the received signal strength indication (“RSSI”) and data rate at time T₁ with the RSSI and data rate at time T₂. The packet decoding success rates at times T₁ and T₂ may be compared and evaluated with the RSSI and data rates to further improve the distance estimation. While only two time points are shown, any number of points may be employed. Thus, the client device 508 may be placed in a vehicle and data may be obtained continuously or at predetermined time increments. Furthermore, the rate of speed of the client device 508 may be factored into the analysis as well.

In a further example, the client device scanning or sniffing transmitted frames may include a receiver with multiple antennas and/or multiple receive chains. Such architectures may be used to provide spatial and/or temporal diversity and give a “stereo” effect which can improve the accuracy of the triangulation calculations. For instance, in one embodiment two separate receivers are located on either side of a vehicle. Both receivers may be electrically connected a single processing device (e.g., a laptop), and both may scan for data packets simultaneously. As with the moving example discussed with respect to FIG. 5, the difference in RSSI and packet decoding success rate for each receiver may improve the distance estimation. Of course, more than two receivers and/or antennas may be employed.

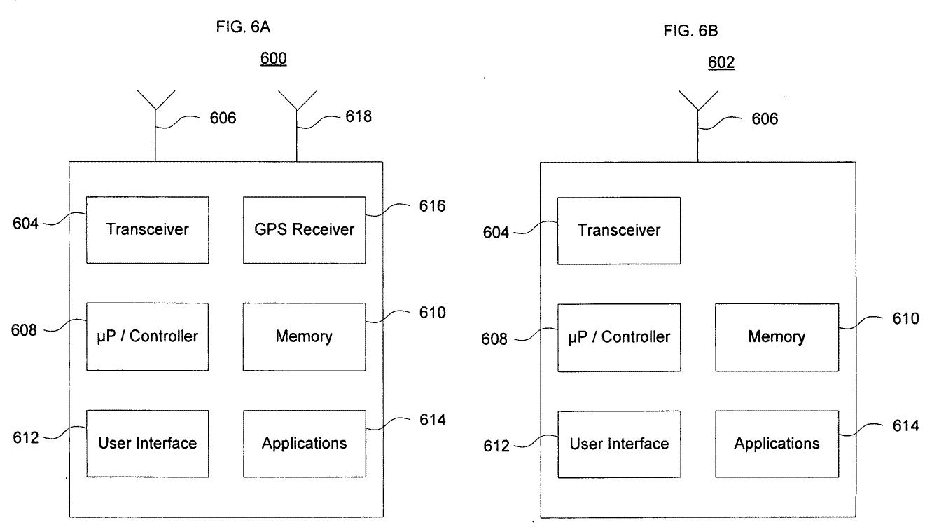

FIGS. 6A and 6B illustrate general architectures of wireless devices for use in accordance with the present invention. Specifically, FIG. 6A provides an exemplary GPS-enabled device 600 while FIG. 6B provides an exemplary device 602 which is not GPS enabled. As shown in FIGS. 6A and 6B, each device 600 and 602 may include a transceiver 604 which is operable to send and receive data packets over a Wi-Fi® or other type of WLAN using an antenna 606. Although a single antenna 606 is shown, multiple antennas (and/or multiple receive chains) may be used for diversity purposes as explained herein.

Each device may also include a microprocessor or controller 608 and memory 610 for storing instructions and/or data. A user interface 612 may be provided along with one or more applications 614. The applications 614 may be stored in an application memory (not shown) or may be stored in memory 610. The key differences as shown between the devices 600 and 602 are the GPS receiver 616 and associated antenna 618 of the device 600. The GPS receiver 616 may be implemented in hardware, software or some combination. The GPS receiver 616 is used to identify a location of the device 600. Referring back to the earlier example of FIG. 3, the client device 308 may be a GPS-enable device such as device 600, while the client device 306 and/or the AP 302 may be configured without a GPS receiver such as device 602.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims. Furthermore, while particular processes are shown in a specific order in the appended drawings, such processes are not limited to any particular order unless such order is expressly set forth herein.

1. A computer-implemented method of estimating the location of a wireless device, the method comprising:
obtaining a packet of data transmitted from a first wireless device to a second wireless device;
determining whether one of the first and second wireless devices is a wireless access point;
determining the data rate of the transmitted data packet;
if one of the first and second wireless devices is the wireless access point, then evaluating the determined data rate against a predetermined criterion; and
assigning an estimated location to the wireless access point based upon the evaluation.

2. The method of claim 1, wherein the predetermined criterion is stored in a look-up table and the evaluation includes identifying a distance in the look-up table associated with the determined data rate.

3. The method of claim 1, wherein:
the transmitted data packet is obtained by a client device; and
the method further includes identifying a distance associated with the data rate, wherein the distance is used as a separation between the first wireless device and the client device.

4. The method of claim 3, wherein the client device is at a known location and the method further comprises:
assigning a distance between the wireless access point and the client device to be the same as the distance between the first wireless device and the client device; and
triangulating a position of the wireless access device using the known location of the client device, the distance between the first wireless device and the client device and the distance between the wireless access point and the client device to obtain the estimated location.

5. The method of claim 4, wherein the client device uses a GPS receiver to obtain the known location.

6. The method of claim 1, wherein the predetermined criterion includes a worst-case distance estimate based upon at least one parameter.

7. The method of claim 6, wherein the at least one parameter includes one or more of a channel propagation characteristic, a transmitter characteristic and a receiver characteristic.

8. The method of claim 1, further comprising revising the estimated location of the wireless access point based upon multiple data packets sent or received by the wireless access point.

9. The method of claim 1, further comprising:
determining a position of the client device based upon the estimated location of the wireless access point; and
providing a location-based service to the client device based on the determined position.

10. A computer-implemented method of estimating confidence in a status of a wireless device, the method comprising:
obtaining one or more packets of data transmitted from a first wireless device to a second wireless device;
evaluating the one or more transmitted data packets to identify a frame type for each respective data packet;
identifying the first wireless device or the second wireless device as a wireless access point based upon the identified frame type for at least one of the data packets; and
assigning a confidence value to the identification of the wireless access point.

11. The method of claim 10, wherein:
if the frame type of at least one of the respective data packets is a management frame, then identifying the first wireless device as a wireless access point; and
setting the confidence value for the identification of the wireless access point to a maximum confidence value.

12. The method of claim 11, wherein:
if the frame type of at least one of the respective data packets is not the management frame, then evaluating whether the frame type of any of the respective data packets is a control frame;
if the frame type of at least one of the respective data packets is the control frame, then identifying the first wireless device as the wireless access point; and
setting the confidence value for the identification of the wireless access point to a value between the maximum confidence value and a minimum confidence value.

13. The method of claim 10, wherein identifying the first wireless device or the second wireless device as the wireless access point further includes analyzing a number of frames transmitted or received by each device.

14. A computer-implemented method of estimating confidence in a location of a wireless device, the method comprising:
obtaining one or more packets of data transmitted from a first wireless device to a second wireless device;
determining that the first or second wireless device is a wireless access point based upon the transmitted packets;
determining an estimated location of the wireless access point; and
assigning a confidence value to the estimated location.

15. The method of claim 14, wherein the confidence value represents a percentage likelihood that the wireless access point is contained within a specified area of interest.

16. The method of claim 14, wherein the estimated location is based on multiple data points.

17. The method of claim 16, wherein a confidence code is applied to each data point.

18. The method of claim 17, wherein the confidence code for each data point is calculated using a weighted function.

19. The method of claim 17, wherein the confidence code for each data point represents a likelihood that that data point is valid or an outlier.

20. An apparatus including a processor operable to estimate the location of a wireless device, the processor executing a process to:
obtain a packet of data transmitted from a first wireless device to a second wireless device;
determine whether one of the first and second wireless devices is a wireless access point;
determine the data rate of the transmitted data packet;
if one of the first and second wireless devices is the wireless access point, then evaluate the determined data rate against a predetermined criterion; and
assign an estimated location to the wireless access point based upon the evaluation.

21. A computer-readable recording medium recorded with a computer program for use by a processor to perform a process of estimating the location of a wireless device, the process comprising:
obtaining a packet of data transmitted from a first wireless device to a second wireless device;
determining whether one of the first and second wireless devices is a wireless access point;
determining the data rate of the transmitted data packet;
if one of the first and second wireless devices is the wireless access point, then evaluating the determined data rate against a predetermined criterion; and
assigning an estimated location to the wireless access point based upon the evaluation.

22. An apparatus including a processor operable to estimate confidence in a status of a wireless device, the processor executing a process to:
obtain one or more packets of data transmitted from a first wireless device to a second wireless device;
evaluate the one or more transmitted data packets to identify a frame type for each respective data packet;
identify the first wireless device or the second wireless device as a wireless access point based upon the identified frame type for at least one of the data packets; and
assign a confidence value to the identification of the wireless access point.

23. A computer-readable recording medium recorded with a computer program for use by a processor to perform a process of estimating confidence in a status of a wireless device, the process comprising:
obtaining one or more packets of data transmitted from a first wireless device to a second wireless device;
evaluating the one or more transmitted data packets to identify a frame type for each respective data packet;
identifying the first wireless device or the second wireless device as a wireless access point based upon the identified frame type for at least one of the data packets; and
assigning a confidence value to the identification of the wireless access point.

24. An apparatus including a processor operable to estimate confidence in a location of a wireless device, the processor executing a process to:
obtain one or more packets of data transmitted from a first wireless device to a second wireless device;
determine that the first or second wireless device is a wireless access point based upon the transmitted packets;
determine an estimated location of the wireless access point; and
assign a confidence value to the estimated location.

25. A computer-readable recording medium recorded with a computer program for use by a processor to perform a process of estimating confidence in a location of a wireless device, the process comprising:
obtaining one or more packets of data transmitted from a first wireless device to a second wireless device;
determining that the first or second wireless device is a wireless access point based upon the transmitted packets;
determining an estimated location of the wireless access point; and
assigning a confidence value to the estimated location.

26. An apparatus for use in a wireless network, the apparatus comprising:
memory for storing information associated with a plurality of devices in the wireless network;
means for communicating with one or more of the plurality of devices in the wireless network; and
a processor operable to estimate a location of an access point device in the wireless network based upon data packet information sent to or received from the access point device;
wherein the processor is adapted to provide location based service information to one or more client devices associated with the access point device upon estimation of the location.

27. The apparatus of claim 26, wherein the data packet information for a given data packet includes a data rate of the given data packet, the information stored in the memory includes distance estimates associated with different data rates, and the processor determines the location estimate of the access point device by comparing the data rate of the given data packet to the different data rates and distance estimates stored in the memory.

28. The apparatus of claim 26, wherein the processor is operable to estimate the location of the access point device using the data packet information for multiple data packets sent to or received from the access point device, and wherein the processor is further operable to rank the data packet information for each of the multiple data packets to obtain approximate distances based upon each such packet.

29. The apparatus of claim 28, wherein the processor estimates the location using a centroid of the approximate distances.

30. The apparatus of claim 28, wherein the processor is further operable to assign a confidence in the estimated location of the access point device.

31. The apparatus of claim 30, wherein the confidence represents a likelihood that the access point device is within a given area.

32. The apparatus of claim 30, wherein the confidence is based upon at least one of spatial diversity of selected devices associated with the access point device, receiver characteristics of the selected devices, transmitter characteristics of the selected devices, and freshness of information stored in memory or the data packet information sent to or received from the access point device.

33. The apparatus of claim 26, wherein the processor comprises a plurality of processing devices in a distributed architecture and the memory stores the information so that the information is accessible to one or more of the plurality of processing devices.
